(19) United States
(12) Patent Application Publication
(10) Pub. No.: US 2024/0253334 A1
(43) Pub. Date: Aug. 1, 2024

(54) VACUUM LAMINATION PROCESS OF A RIGID CELLULOSE BODY FOR FOOD PACKAGING

(71) Applicant: SOCIETE DES PRODUITS NESTLE S.A., Vevey (CH)

(72) Inventors: AGATHE MOUREN, La Seyne Sur Mer (FR); JULIEN BRAS, St Martin d'Uriage (FR); JULIA CHARDOT, Buc (FR)

(21) Appl. No.: 18/559,957

(22) PCT Filed: May 10, 2022
(86) PCT No.: PCT/EP2022/062536

§ 371 Date: Nov. 9, 2023

(30) Foreign Application Priority Data
May 11, 2021 (EP) 21173376.1

(51) Int. Cl. B32B 27/10; B32B 1/00; B32B 3/26; B32B 37/10; B65D 25/14

(52) U.S. Cl. CPC B32B 27/10; B32B 1/00; B32B 3/266; B32B 37/1018; B65D 25/14; B32B 2307/7163; B32B 2307/7376; B32B 2439/02; B32B 2439/70

(57) ABSTRACT

The present invention relates to a vacuum lamination process, in which a three-dimensional rigid body (100) is provided for being laminated. The body (100) has a wall section (110) delimiting an open body volume (111) and comprises a see-through hole (120) penetrating the wall section (110). A laminate (200) is provided and spanned at least over the body volume (111). A vacuum is applied at least via the see-through hole (120) so that the laminate (200) is laminated onto the body (100) at least at the wall section (110) to cover the see-through hole (120). The invention further relates to a laminated three-dimensional rigid body (101, 102) comprising a three-dimensional rigid body (100) with a see-through hole (120) penetrating its wall section (110) and being covered by the laminate (200). Moreover, the invention relates to a container (300) comprising two three-dimensional rigid bodies (101, 102), of which at least one is said three-dimensional rigid body (101, 102). The two three-dimensional rigid bodies (101, 102) are connected to each other to form a closed container volume (312).

### 1. FIELD OF THE INVENTION

The present invention relates to a vacuum lamination process for laminating a rigid three-dimensional body under vacuum. The invention further relates to a laminated three-dimensional rigid body and a container comprising at least one said laminated three-dimensional rigid body.

### 2. TECHNICAL BACKGROUND

In the prior art, a multitude of packaging applications, such as the packaging of food products, relies on plastic materials as a packaging material. Reasons for this are that plastic materials offer numerous advantages, such as formability, durability, flexibility, low weight, provision of long shelf-life and leaving the packaged product unaltered. Unfortunately, disposing, reusing and recycling of plastic materials is challenging.

Therefore, attempts are made to replace plastic materials with alternative materials that overcome the problems with disposing and/or recycling of used packaging. For example, fibre-based materials, e.g. paper, cardboard or pulp, and bioplastics are proposed as alternatives to plastic materials as they facilitate recycling and/or composting. However, fibre-based materials do not inherently possess a reliable oxygen, fat and/or moisture barrier. In comparison, bioplastics offer the advantage of (selectively) providing a moisture and/or gas barrier while being water resistant and/or lipophobic. However, bioplastics often lack a level of stiffness commonly required in packaging applications. Thus, approaches exist that rely on fibre-based materials being laminated with bioplastics to arrive at a packaging that is comparable to the former plastic packaging.

Therein, laminating under vacuum conditions was found to be advantageous. In a vacuum lamination process, typically vacuum is applied to suck a laminate onto a surface of a body that is to be laminated. An example for this type of lamination process is described in EP 2 987 623 A1. However, it can be found that this kind of lamination process is limited to bodies made from materials that possess a high level of porosity in order to allow for pulling and attaching the laminate firmly and evenly onto the surface by suction force. Thus, the lamination process and packaging are restricted to certain material combinations. For the same reasons, the process has limitations regarding the shapes and forms of the body as well as regarding the maximum depth of the body, up to which a sufficient lamination result is achievable. Accordingly, present packaging solutions are restricted to certain body shapes and sizes. Attempts of producing packaging, such as trays or containers, outside these limits appeared to be unsuccessful as the laminate did not reliably attach to the body to be laminated.

The described limitations are, however, disadvantageous since packaging applications of various fields, such as food packaging, often require that the body has a certain amount of compactness (and thus, only a small level of porosity) to provide the packaging with corresponding mechanical and chemical properties (e.g. certain level of mechanical stiffness; impermeability to foreign matter, e.g. bacteria, or gas). Also, the restrictions on the size and shape of the packaging are disadvantageous for designing packaging for various products.

Therefore, it is an object of the invention to provide a vacuum lamination process, a three-dimensional body and a container that allow to overcome the known drawbacks of established packaging solutions, respectively. Therein, it is an object of the invention to provide a voluminous packaging or body that is made from a laminated compact material. It is a further object of the invention to provide a vacuum lamination process that facilitates the production of such improved packaging. Moreover, it is an object of the invention to provide a process, a body and a packaging, in which recyclable and/or compostable packaging materials for packaging food products can be used.

### 3. SUMMARY OF THE INVENTION

These and other objects, which become apparent upon reading the description, are solved by the subject-matter of the independent claims. The dependent claims refer to preferred embodiments of the invention.

A first aspect of the invention relates to a vacuum lamination process, in which a three-dimensional rigid body (in the following also referred to as the “body” or the “rigid body”) to be laminated is provided. The body has a wall section delimiting an open body volume. The body comprises a see-through hole that penetrates the wall section. A laminate is provided. The laminate is spanned at least over the body volume. A vacuum is applied at least via the see-through hole so that the laminate is laminated onto the body at least at the wall section to cover the see-through hole.

In other words: A process for laminating (i.e. (permanently) connecting/providing a substrate with a layer of laminate material, for example) a three-dimensional rigid body is provided that is completed at least partially under vacuum conditions. Therein, the term “vacuum” may be understood, for example, as a space or volume, where a pressure exists below a pressure of its surroundings and/or below normal atmospheric pressure. Thus, for instance, vacuum may be understood as occurrence of relative low pressure within a (defined) space or volume.

The (three-dimensional) body is rigid. Therein, the term “rigid” may be understood as an ability of the material to resist deformation in response to an applied mechanical load; e.g. of a product filled in the volume or a gripping force of a user to grasp and carry the body preferably filled with a product. This ability may preferably originate from a compactness of the material of the body or inherent to the body. For example, the rigid body may comprise a porosity and/or density that facilitates the material being mechanically inflexible and/or being gas impermeable to a certain extent.

For fibre-based materials, for example, the bending stiffness may be determined in tests following ISO 2493. For example, the rigid body may comprise a bending stiffness between 400 Nm and 3500 Nm. The rigid body may preferably comprise a grammage between 300 g/m² and 800 g/m². Preferably, the rigid body may comprise a density in the range of 250 kg/m³ to of 1000 kg/m³. Further, the rigid body may comprise a porosity (expressed as a fraction of the volume of voids over the total volume as a percentage) between 1% and 20%. Alternatively or additionally, the rigid body may comprise an air resistance (e.g. determined in the Gurley method, ISO 5636, as a time, in seconds, that it takes for 100 ml of air to pass through the sheet) from at least 160 Gurley seconds.

The body has a wall section delimiting an open body volume, which, for example, may be understood as a (defined) space having length, height and width, and which may be open on at least one side. Preferably, the wall section may enclose or surround the body volume such that an opening to the space enclosed by the wall section is provided with an opening. Further, the body comprises a see-through hole that penetrates the wall section, which may be understood as a hole or aperture (configured) to be looked through using human vision (only).

A laminate is provided. Therein, the term “laminate” may be understood as a film, a membrane, or a thin sheet of material (for lamination). Preferably, before lamination, the laminate may be a material separate from the object to be laminated. Accordingly, after lamination, a laminated object may have a structure, for example, comprising different parts that may be arranged in layers, plies, slats, tiers or as strata, wherein preferably the laminate may form one of the layers, plies, slats, tiers or strata. The laminate is spanned over at least the body volume. Thereby, the laminate may (fully) extend, cover or stretch over the body volume or it may be arranged to overlap with the body volume.

A vacuum is applied at least via the see-through hole so that the laminate is laminated onto the body at least at the wall section to cover the see-through hole. Thus, laminating is completed in a state of reduced or lowered pressure, for example. This state may be actively induced, for example. A surface enclosed by the see-through hole may be overlapped (covered) by the laminate, for example, by forming a layer or cover over it.

Thus, with the vacuum lamination process of the invention it is possible to overcome the drawbacks of known packaging solutions. In particular, the provision of a see-through hole in a wall section of the body allows to use materials that are more compact, structurally more complex, and larger in size (depth) as the see-through hole facilitates an even and equal distribution of suction forces across the surface of the body to be laminated. Accordingly, vacuum lamination can be made available for packaging applications where high requirements are set on barrier and stiffness properties. Also, an improved adhesion of the laminate to the body especially in corners and deeper parts of the body can be achieved. Accordingly, the body can be provided with complex body structures in the lamination process. Surprisingly, the inventors found that the provision of an opening was not accompanied by a reduction in the mechanical strength of the resulting laminated body. Therein, a prejudice of prior art has overcome that an opening in the body structure would automatically bring structural weakness to the body and thus, would be disadvantageous. Instead, in addition to being a facilitator for the vacuum lamination process, the see-through opening can be used as a filling level indicator or visualizer of the product. For example, the see-through hole can be an aesthetic eye catcher visualising the quality of the product.

Further, it is to be noted that rigidity and/or compactness may be achieved structurally, for example by providing the body with thick walls, or chemically, for example by providing the body from a certain material or providing it with a certain coating or a laminate that stops gasses permeating through the body. For example, it is conceivable that at first a gas permeable rigid body may be provided, which is then laminated to provide the required rigidity as well as the required compactness. Starting from here, it would be possible with the present invention to laminate such processed body again and thus, provide the rigid body with additional layers. Thus, the present invention improves also the number of applications, in which vacuum lamination process can be used.

According to a preferred embodiment, before spanning the laminate at least over the body volume, the laminate may be heated. For example, infrared heating or a stream of hot air may be used. Preferably, the laminate may be heated at a temperature between 100° C. and 250° C. Preferably, also the body may be heated.

By warming up the laminate, for example by increasing the temperature of its surroundings, the laminate becomes more malleable and pliable so that the laminate may adapt better to the contours of the surface of the body to be laminated. In addition, the adhering/bonding strength between the body and the laminate can be improved.

According to a further preferred embodiment, before spanning the laminate at least over the body volume, gas may be insufflated to bulge the laminate away from the body volume. Preferably, the gas may be air, CO₂ and/or an inert gas. The gas may be introduced laterally from the wall section and/or at least via the see-through hole. Preferably, this step of gas insufflation may be completed after heating the laminate.

By introducing gas into the process space (for example by blowing gas onto the body), the laminate can be bent away from the body volume, preferably such that the laminate forms a convex curve protruding outwards with respect to the body volume. Thereby, the laminate can be brought not only into a position where it does not collide with the body, but also where it can be ensured that no wrinkles or folds exist in the laminate. Accordingly, the quality of adhesion between laminate and body can be improved. Also, the laminate can follow the contour of the body without the risk of entrapping gas between the laminate and the body. These effects can be amplified by the see-through hole as the gas can be distributed more evenly over the surface to be laminated.

According to a preferred embodiment, the body may comprise a plurality of see-through holes.

Thereby, it is possible to amplify the aforementioned effects as gas between the body and the laminate can be removed or introduced more freely and evenly.

A further aspect of the present invention relates to a laminated three-dimensional rigid body (in the following also referred to as the “laminated body”). It comprises a three-dimensional rigid body (as mentioned, in the following also referred to as the “body” or the “rigid body”) having a wall section delimiting an open body volume. The body comprises a see-through hole penetrating the wall section. At least the wall section is laminated with a laminate to cover at least the wall section and the see-through hole.

Thereby, a laminated body is provideable with better bonding qualities between the laminate and the body resulting from a vacuum lamination process despite being less restricted on its size. In addition, different material combinations can be used for the body and laminated body. In particular, it is possible to provide a body that has similar or equal characteristics as plastic materials but that may be produced entirely from recyclable, biodegradable and/or compostable materials. In addition, the body has at least one see-through hole that can be used as a level indicator and for aesthetic improvement of the laminated body, e.g. a packaging.

According to a preferred embodiment, the body may comprise a plurality of see-through holes, which is (are) covered by the laminate. Preferably, the see-through holes may be evenly or unevenly distributed over the wall section.

Thereby, it is possible to improve the bonding between the laminate and the body in a vacuum lamination process even further and thereby, to laminate a body with a laminate layer that covers reliably a complex surface contour of the body. In addition, it is possible to use the multiple see-through holes as different level indicators without deteriorating the stability and mechanical strength of the body.

Preferably, the see-through hole(s) may be positioned at or in a transition area of the wall section defining the three-dimensional shape of the body. For instance, the transition area can be a bend or a dent in the wall section. Preferably, if a plurality of see-through holes are present, the see-through holes may be evenly or unevenly distributed at or along the transition area.

Thereby, lamination or covering of the see-through holes is facilitated as being positioned in a stable and preferably protected area allowing for a good lamination-ability.

According to a further preferred embodiment, the largest extension E of the see-through hole may be E≤20 mm or E≤15 mm or E≤10 mm or E≤5 mm. Alternatively or additionally, the largest extension of the see-through hole may be E≥1 mm or E≥2 mm. Alternatively or additionally, the largest extension E of the see-through hole may be in a range of 1 mm≤E≤10 mm or 2 mm≤E≤5 mm. For example, the largest extension E may be a diameter, a length or width of the see-through hole.

Thereby, a balance can be found between the structural integrity and the ability of improving the quality of the adhesion (bond) between the laminate and the body in a vacuum lamination process. Also, the preferred configuration facilitates that sufficient visibility of a product inside the (laminated) body through the see-through hole can be ensured.

According to a preferred embodiment, the rigid body may be made from a cellulose material or fibre-based material, like molded pulp. For example, the cellulose or fibre-based material may be wood pulp, sugarcane pulp, bagasse pulp, non-wood pulp, and/or cellulose based pulp in any form.

Thereby, it is possible to provide the body from a recyclable, biodegradable and/or compostable material so that the ecological impact of packaging produced from the body can be reduced. Moreover, the above materials allow to mould the body to the required shape so that the areas of application can be increased.

According to a further preferred embodiment, the rigid body may have a material thickness B of 200 μm≤B≤1200 μm, preferably 200 μm≤B≤1000 μm.

Thereby, the rigidity and/or compactness of the body can be ensured and increased. Accordingly, the body can be provided with a sufficient gas barrier and mechanical strength that is required for several applications.

According to a preferred embodiment, the laminate may be a compostable and/or biodegradable material, preferably a polymer material. Alternatively or additionally, a bio-based or petro-based material, preferably polymer material, may be used.

Therein, the term “compostable” may be understood as meaning that a material may be substantially broken down into organic matter within a few weeks or months when it is composted. This may be accomplished in industrial composting sites and/or home composters. Specific conditions relating to wind, sunlight, drainage and other factors may exist at such sites. At the end of a composting process, the earth may be supplied with nutrients once the material has completely broken down. International standards, such as EU 13432 or US ASTM D6400, provide a legal framework for specifying technical requirements and procedures for determining compostability of a material. For example, one of the tests for compostability requires that—to be considered “industrially compostable”—at least 90% of the material in question is to be biologically degraded under controlled conditions within 6 months. Similar tests exist for certification as home composting.

In comparison, the expression “biodegradable material” may be understood as any material that can be broken down into environmentally innocuous products by (the action of) living things (such as microorganisms, e.g. bacteria, fungi or algae). This process could take place in an environment with the presence of oxygen (aerobic) and/or otherwise without presence of oxygen (anaerobic). This may be understood, for example, as meaning that composting can be carried out without reservation. At the end of such composting processes, there are no residues of the material, which may be problematic for the environment, or any non-biodegradable components.

Thereby, it is possible to reduce the environmental impact of the laminated body, e.g. a packaging produced with the body, and to facilitate recycling and/or composting thereof after its usage.

Preferably, the laminate may be made of a stretchable material, such as a polymer material. For example, the laminate may have a tensile strength between 10 MPa and 100 MPa. Preferably, the stress-strain behaviour of the laminate may be temperature dependent. More preferred, the laminate may be an elastomer or may have a material behaviour similar or the same as an elastomer.

Thereby, it is possible to expand the laminate over the body during a vacuum lamination process so that the laminate can be adhered more evenly onto the contours of the surface of the body to be laminated. Also, the laminate can adapt more easily to the contours of the surface. In addition, the see-through hole can be provided with a material that is able to dissipate a mechanical load applied regardless of the side of the see-through hole, from which the load is exerted.

Alternatively or additionally, a translucent and/or transparent material may be used for the laminate, such as a polymer material. Preferably, the material may include a filter for certain wavelengths of light that may be deteriorating the quality of food products. Thereby, the see-through hole can be provided as visually transmitting so that it can be used as a level indicator or as an opening for product visualisation.

According to a further preferred embodiment, the laminate may comprise any one or any combination of polylactic acid (PLA), polybutylene adipate terephthalate (PBAT), thermoplastic starch (TPS), polyhydroxyalkanoates (PHA), polypropylene (PP), polyethylene (PE), polyethylene terephthalate (PET), polyglycolic acid (PGA) and/or polybutylene succinate (PBS). Alternatively or additionally, the laminate may comprise metal, such as Aluminium and/or a metal suitable for induction sealing, as one of its components. Preferably, the laminate may be at least recyclable.

Thereby, the laminate can be provided from materials that are resistant to water and/or fat. Moreover, the materials may have barrier properties to block gas or external matter passing through the body and/or the see-through hole. In addition, the materials can be provided with tensile strength sufficient for being used in vacuum lamination processes. Further, the materials may be biodegradable and/or may be sourced from plants.

According to a preferred embodiment, the laminate may comprise a layered structure, which preferably may comprise any combination of one or more of the aforementioned group of materials, such as PLA, PBAT, TPS, PHA, PP, PE, PET, PGA and/or PBS. Preferably, the laminate may comprise also at least one layer made from metal, such as an Aluminium foil.

The multi-ply structure of the laminate can allow to provide the body with a combination of different characteristics as multiple materials can be used for the individual layers. Thus, the body can be tailored to the requirements of the individual application. Thereby, it is possible to avoid having to use conventional plastic materials instead of biodegradable and/or compostable materials.

According to a further preferred embodiment, the laminate may have a material thickness T of 25 μm≤T≤150 μm, preferably 60 μm≤T≤100 μm.

Thereby, a balance can be found between providing the see-through hole and/or the body with a layer of laminate, which offers sufficient strength and sealing properties, and keeping the laminate stretchable. Also, the so configured laminate can be attached evenly and firmly to the body in a vacuum lamination process so that the body receives the capability of being provided with an improved adhesion of the laminate to the body.

A further aspect of the present invention relates to a container. The container comprises a first rigid body being a laminated three-dimensional rigid body as described above. The container further comprises a second rigid body. The first rigid body and the second rigid body are connected to each other to form a partially or fully closed container volume that is at least partially delimited by the wall section or that comprises at least the body volume of the first rigid body.

Thereby, it is possible to provide a container that is formed by two connected (i.e., for example, adjoining, touching, linked and/or joined) rigid bodies, which at least partially surround (or enveloping) a space enclosed therebetween. As at least one of the rigid bodies is the above-described laminated three-dimensional rigid body, a container with the same advantages and benefits can be obtained. In particular, a container with a high sealing quality and level indicators can be obtained.

According to a preferred embodiment, the second rigid body may also be a laminated three-dimensional rigid body as described above. Preferably, the second rigid body may be identical to the first rigid body. Preferably, the container volume may be at least partially delimited by the wall sections or the container volume may comprise the body volumes of both rigid bodies, i.e. the first rigid body and the second rigid body.

Thereby, a container with an even higher sealing quality and with level indicators provided on each rigid body can be obtained.

A further aspect of the present invention relates to a laminated three-dimensional rigid body produced in the vacuum lamination process described above.

A further aspect of the present invention relates to a lamination device and a lamination system for completing the steps of the vacuum lamination process described above.

### 4. BRIEF DESCRIPTION OF DRAWINGS

Further features, advantages and objects of the invention will become apparent for the skilled person when reading the following detailed description of embodiments of the invention and when taking in conjunction with the figures of the enclosed drawings.

In case numerals have been omitted from a figure, for example for reasons of clarity, the corresponding features may still be present in the figure.

FIGS. 1 to 4 show schematic illustrations of different steps of an embodiment of a vacuum lamination process according to the invention.

FIG. 5 shows a schematic sectional side view of an embodiment of a container according to the invention comprising two embodiments of a laminated three-dimensional rigid body according to the invention.

FIG. 6 shows a schematic top view of a further embodiment of a laminated three-dimensional rigid body according to the invention.

FIG. 7 shows a schematic top view of an even further embodiment of a laminated three-dimensional rigid body according to the invention.

### 5. DETAILED DESCRIPTION

The Figures show different views and aspects of embodiments of the invention.

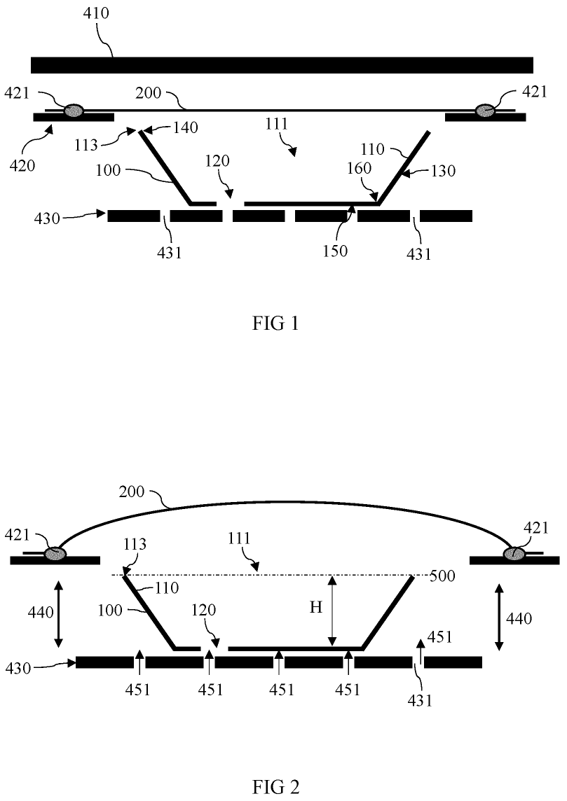

A first aspect of the present invention relates to a vacuum lamination process. The vacuum lamination process comprises a number of different steps, of which some are exemplarily illustrated in FIGS. 1 to 4. For example, the vacuum lamination process may also be referred to as “skin vacuum lamination process”.

In the vacuum lamination process, a three-dimensional rigid body 100 is provided to be laminated. This is exemplarily shown in FIG. 1. Also, FIGS. 2 to 4 exemplarily show the body 100 being present in various process steps.

The body 100 extends in three-dimensions. The body 100 may have any shape or form. For example, the body 100 may be a block, a shell, a tray, bowl shaped or (half-)bottle shaped. The body 100 may be hollow. The body 100 may comprise a space or cavity that may be accessible from at least one side. The body 100 may be symmetrical or asymmetrical. The dimensions of the body 100 may be defined by a body length, body width and body height. Preferably, the body length may be in the range of 5 cm to 50 cm. The body width may be in the range of 5 cm to 50 cm. The body height may be in the range of 5 cm to 50 cm. However, these are only examples and not to be understood as limiting.

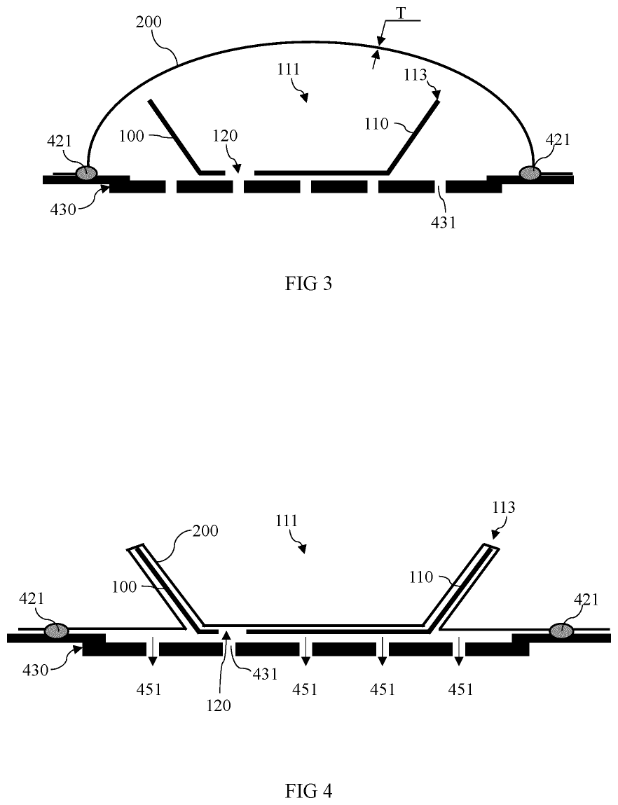

The body 100 is rigid. Preferably, the rigidity of the body 100 may be defined by the consistency and/or composition of its material. For example, the body 100 may be made from a recyclable, biodegradable, and/or compostable material. For instance, the body 100 may be made from a fibre-based material or, more specifically, a cellulose material, like molded pulp. However, it is also conceivable to provide the body 100 from different (compostable) materials, a plastic material and/or a metallized paper material. Alternatively or additionally, the rigidity of the body 100 may be defined by the thickness of the structures defining (contours of) the body 100. For example, the body 100 may have a structure for providing a sufficient axial stiffness or bending stiffness to resist typical forces (e.g. 25N) or bending moments (e.g. 1 Nm) occurring in the intended application. Preferably, the body 100 may have a material thickness B of 200 μm≤B≤1200 μm, preferably 200 μm≤Bs1000 μm. This may be particularly relevant, for example, if the body 100 may be provided from a fibre-based material, like cellulose. The material thickness B is exemplarily indicated in FIG. 5.

The body 100 may be provided, for example, by being placed on a work surface 430 of a (preferably movable) platform. This is exemplarily illustrated in FIGS. 1 to 4. Preferably, the work surface 430 may comprise slots 431 that form passages between opposite sides of the work surface 430. The work surface 430 and/or the platform may be part of a lamination device or of a lamination system.

The body 100 has a wall section 110. Preferably, the wall section 110 may extend along the entire circumference (i.e. an outside edge) of the body 100 (in a top view). The wall section 110 may extend in all three dimensions of the body 100. The wall section 110 may define the shape and/or contours and/or limits of the body 100. This is exemplarily indicated in all Figures. The wall section 110 may have the material thickness B.

The wall section 110 delimits an open body volume 111. This is exemplarily illustrated in all Figures. Preferably, the wall section 110 may define the body volume 111 such that a free space inside the body 100 is formed. The free space may be accessible through an opening being delimited and/or defined by the wall section 110. Preferably, the body volume 111 may be suitable as a receptacle for receiving a product, such as food products. For example, the body 100 (and/or the body volume 111) may be formed as a half-shell or a bowl. Preferably, the body 100 may have an upper side comprising an access opening 140 to the body volume 111 and an opposite lower side forming a base portion 150 of the body 100, as exemplarily shown in FIG. 1. Preferably, the body 100 may be placed on the work surface 430 (of the platform) with its lower side 150. This is exemplarily illustrated in FIGS. 1 to 4. However, this is only an example and other configurations and orientations of the body 100 are conceivable. Preferably, the body volume 111 (and/or the free space comprised therein) may have a depth H extending between the access opening 140 of the body volume 111 and the base portion 150 of the body volume 111 opposite thereto. Preferably, the depth H may be in the range of 1 cm to 8 cm. However, these are only examples and not to be understood as limiting. The depth H is exemplarily illustrated in FIG. 2.

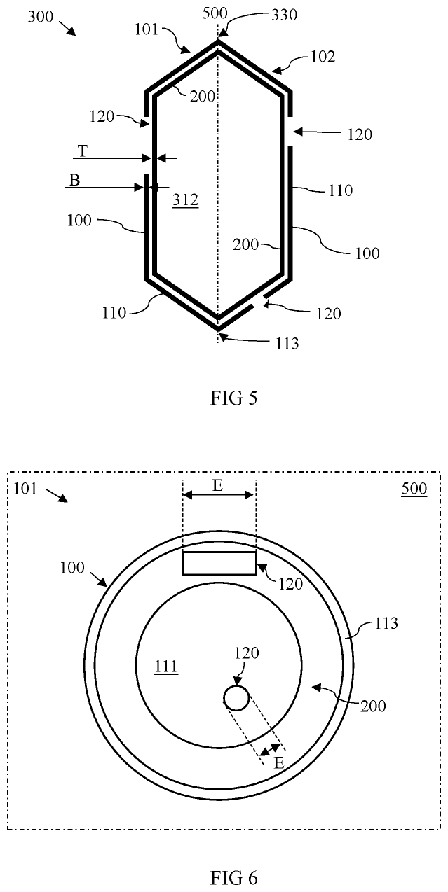

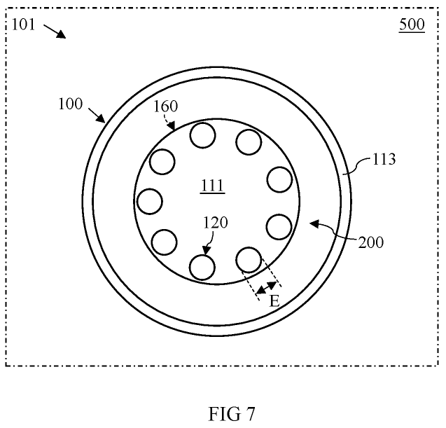

The body 100 comprises at least one see-through hole 120 penetrating the wall section 110. Accordingly, it is also conceivable that the body 100 may comprise a plurality of see-through holes 120. The see-through hole(s) 120 may be positioned at or in a transition area 160 of the wall section 110 defining the three-dimensional shape of the body 100. This transition area 160 can be a bend or a dent in the wall section 110, like the bend 160 between the base section 150 and a lateral wall section 130 of the wall section 110, as exemplarily shown in FIG. 1. The see-through holes 120 may be distributed evenly or unevenly around the body 100, preferably at or along the transition area 160, as exemplarily shown in FIG. 7. The see-through hole 120 may have any shape or form. For example, the see-through hole 120 may have a circular, oval, rectangular, quadratic and/or curved form. This is exemplarily illustrated in all Figures. However, this is not a complete enumeration and other configurations of the see-through hole(s) 120 are conceivable. Preferably, the see-through hole(s) 120 may form a passage between the lower side of the body 100 and the free space (the open body volume 111) delimited by the wall section 110. This is exemplarily illustrated in FIGS. 1-3. Preferably, the largest extension E of the see-through hole 120 may be E≤20 mm or E≤15 mm or E≤10 mm or E≤5 mm. Alternatively or additionally, the largest extension E may be E≥1 mm or E≥2 mm. Alternatively or additionally, the largest extension E of the see-through hole 120 may be in a range of 1 mm≤E≤10 mm or 2 mm≤E≤5 mm. For example, the largest extension E may be a diameter of the see-through hole(s) 120 in case the see-through hole(s) 120 may have a circular shape such as illustrated in FIGS. 6 and 7. Generally, the size of the see-through hole(s) 120 may be dependent on the relative position of the see-through hole(s) 120 with respect to the base portion 150 and/or the access opening 140. Thereby, structural weaknesses and/or peculiarities of the body 100 or of the intended application can be taken into consideration. The body 100 may comprise a multitude of see-through holes 120 that may be all the same (such as exemplarily illustrated in FIG. 7) or that may be at least partially different to each other (such as exemplarily illustrated in FIG. 6). Therein, the see-through holes 120 may be different in shape and/or size.

The body 100 and/or the wall section 110 may comprise a flange portion 113. Preferably, the flange portion 113 may extend in a (single) plane 500. This is exemplarily illustrated in all Figures. Preferably, the plane 500 may be parallel to the base portion 150 of the body 100. Preferably, the flange portion 113 may circumferentially surround the access opening 140 to the body volume 111, which may be delimited by the wall section 110. The flange portion 113 may be suitable for being connected to a corresponding connecting portion of a second body for forming a receptacle, such as a container. Preferably, the flange portion 113 may be configured to be operated during sealing, such as heat sealing, ultrasonic sealing and/or induction sealing.

In the vacuum lamination process, a laminate 200 is provided. This is exemplarily shown in FIG. 1. Also, the laminate 200 is exemplarily shown in FIGS. 2 to 7.

The laminate 200 may be made from a bio-based or petro-based material. For example, the material of the laminate 200 may be a polymer. Preferably, the laminate 200 may be biodegradable. For example, the laminate 200 may be any combination of one or more of the group of PLA, PBAT, TPS, PHA, PP, PE, PET, PGA and/or PBS. Preferably, the laminate 200 may comprise a layered structure, such as a multi-ply structure. The layered structure may comprise any combination of the aforementioned group of materials. The laminate 200 may be stretchable, translucent and/or transparent. Alternatively or additionally, the laminate 200 may be water resistant and/or fat resistant. Preferably, the laminate 200 may be suitable for providing an oxygen and/or UV radiation barrier. Alternatively or additionally, the laminate 200 may be a sealant, for example, to be used in heat sealing applications. The laminate 200 may be a film or a foil. The laminate 200 may have a material thickness T of 25 μm≤T≤150 μm, preferably 60 μm≤T≤100 μm. In case of a multi-ply structure, for example, the material thickness T may be the total thickness. FIGS. 3 and 5 show this exemplarily.

The laminate 200 may be provided on a reel. Preferably, the laminate 200 may be secured in a holding module 420 of the lamination device or of the lamination system. The holding module 420 may comprise clamps 421 or pushers for securing the laminate 200 on opposite sides thereof.

The laminate 200 may be provided having a temperature between 100° C. and 250° C. For this, a heating module 410 may be provided to increase the temperature of the laminate 200. For example, the heating module 410 may be an infrared heater or a fan heater.

This is exemplarily illustrated in FIG. 1. It is also conceivable that the heating module 410 heats the body 100.

In the vacuum lamination process, the laminate 200 is spanned at least over the body volume 111. This is exemplarily illustrated in FIG. 1. Preferably, the laminate 200 may extend fully over the body volume 111. The body 100 may be provided such that the body volume 111 faces the laminate 200 with its open side. Preferably, the access opening 140 delimited by the wall section 110 may be closer to the laminate 200 than the base portion 150 of the body 100 for being placed on the work surface 430. Preferably, the laminate 200 may be spanned parallel to the plane 500 and/or to the flange portion 113. Preferably, the laminate 200 may be spanned such that it forms an area equal or higher than the area delimited by the surface defined inside the body 100 by the wall section 110 (or the body volume 111). However, it is also conceivable that, before spanning the laminate 200 over the body volume 111, the laminate 200 may be heated by the heating module 410, for example by infrared heating, at a temperature between 100° C. and 250° C. FIG. 1 shows this exemplarily. Thereby, for example, the laminate 200 may become more flexible and/or stretchable and/or may be elongated. It is also conceivable that the laminate 200 may be spanned over the body volume 111 under tensile stress to form a substantially planar surface. Alternatively, the laminate 200 may hang loose under gravity and form a catenary.

Furthermore, before spanning the laminate 200 over the body volume 111 and preferably after heating the laminate 200, a gas 451, such as air, may be blown onto the body 100 to bulge the laminate 200 away from the body volume 111. This is exemplarily shown in FIG. 2, where the gas 451 is exemplarily symbolized by arrows indicating an exemplary moving direction. Preferably, the gas 451 may be introduced laterally from the wall section 110 (and/or the base portion 150). Alternatively or additionally, the gas 451 may be insufflated at least via the see-through hole 120. The gas 451 may be introduced such that it moves perpendicularly to the laminate 200. Thereby, the laminate 200 may be stretched and flex away from the body 100. The lamination device or the lamination system may comprise an insufflation module (not illustrated) to blow the gas 451 onto the body 100.

Preferably, the lamination device or the lamination system may comprise a moving module 440 for moving the body 100 (and/or the work surface 430) relatively to the laminate 200 (and/or the holding module 420, preferably the clamps 421). This is exemplarily illustrated in FIG. 2 by double headed arrows. Therein, the clamps 421 may be moved towards the body 100 and/or the body 100 may be moved (standing on top of the work surface 430) with the work surface 430 (e.g. with the movable platform) towards the laminate 200. FIGS. 3 and 4 show the laminate 200 and the body 100 exemplarily in a position close to each other. In FIG. 3, the laminate 200 is exemplarily illustrated as (still) bulging away from the body 100, for example due to the deformation induced by gas insufflation and/or by continuing to blow gas 451 on the laminate 200.

The vacuum lamination process comprises further the step of applying a vacuum at least via the see-through hole 120 so that the laminate 200 is laminated onto the body 100 at least at the wall section 110 to cover the see-through hole 120 thus to form a laminated three-dimensional rigid body 101, 102. This is exemplarily shown in FIG. 4. Arrows orientated away from the body 100 indicate exemplarily the flow of the gas 451 that may be contained in a space delimited between the laminate 200 and the body 100. Preferably, the gas 451 may be removed from the space between the laminate 200 and the body 100 through the slots 431. Therein, a vacuum module may be provided that may comprise, for example, a vacuum pump. Preferably, the space surrounding the area of the body 100 and the laminate 200 may be hermetically sealable in order to generate said vacuum. Alternatively or additionally, the gas 451 may be insufflated onto the laminate 200 from the side opposite to the body 100 with respect to the laminate 200 in order to push the laminate 200 against the body 100. The laminate 200 may cover the inside of the body 100 and/or external surfaces of the body 100. For example, in FIG. 4, inside surfaces (of the body volume 111 and/or of the wall sections 110) as well as outside (external) surfaces of the body 100 are exemplarily illustrated as being laminated. In comparison, in FIG. 5, the laminate 200 is exemplarily illustrated as only covering the inside surfaces of the respective bodies 100 to form the respective laminated bodies 101, 102. The flange portion 113 may be covered by the laminate 200. This is exemplarily illustrated in FIGS. 4 and 5. However, it is also conceivable that the flange portion 113 may remain free from the laminate 200. With the application of vacuum, it is possible to tightly and firmly attach the laminate 200 to the body 100, preferably in a manner that the laminate 200 adheres to the body 100 like a second skin.

Further, the lamination device or the lamination system may comprise a control module to control and/or to coordinate the individual components, respectively, such as the heating module 410, the holding module 420, the work surface 430, the moving module 440, the insufflation module, and/or the vacuum module. The lamination device or the lamination system may also form an independent part of this invention. Preferably, the control module may be configured to complete the vacuum lamination process of the invention. Preferably, the steps may be completed in the order illustrated in FIGS. 1 to 4. However, this is only an example and other orders are conceivable. The lamination device or the lamination system may further comprise a connecting module for ultrasonic sealing and/or for induction sealing of two bodies produced, for example, with the above-described vacuum lamination method.

A further aspect of the present invention relates to a laminated three-dimensional rigid body 101, 102 (that may be preferably produced in the vacuum lamination process described above).

Preferably, the laminated three-dimensional rigid body 101, 102 may comprise the body 100 described above and may be laminated with the laminate 200 described above. In particular, the three-dimensional rigid body 100 has the wall section 110 described above. Therein, the wall section 110 delimits the open body volume 111 and is penetrated by the see-through hole 120. At least the wall section 110 is laminated with the laminate 200 to cover at least the wall section 110 and the see-through hole 120 thus forming the laminated body 101, 102. FIGS. 5 to 7 show examples for the laminated three-dimensional rigid body 101, 102. Preferably, the three-dimensional rigid body 100 may comprise a plurality of see-through holes 120. The see-through hole(s) 120 may be positioned at or in the transition area 160. The see-through holes 120 may be evenly or unevenly distributed over the wall section 110, preferably at or along the transition area 160. Preferably, all of the see-through holes 120 may be covered by the laminate 200. This is exemplarily illustrated in FIGS. 5 to 7.

The three-dimensional rigid body 100 or laminated body 101, 102 may be suitable and/or may be configured for receiving a food product, in particular a liquid food product. The three-dimensional rigid body 100 or laminated body 101, 102 may form at least part of a receptacle, such as a container, for receiving a food product. Preferably, the laminated three-dimensional rigid body 101, 102 may be made at least partially or entirely from food safe materials. More preferred, at least the laminate 200 covering the inside of the body volume 111 may be made from a food safe material.

A further aspect of the present invention relates to a container 300. The container 300 is exemplarily illustrated in FIG. 5. Preferably, the container 300 may be suitable and/or may be configured for receiving a food product. The container 300 may have any shape or form. For example, the container 300 may be a tray, a capsule, a bottle, a box and/or a stand-up packaging.

The container 300 comprises a first rigid body 101 that is the above-described laminated three-dimensional body 101, which preferably may be produced in the above-described vacuum lamination process.

The container 300 comprises further a second rigid body 102. The second rigid body 102 may have any shape or form. The second rigid body 102 may comprise a rigid body being laminated the same way as described for the laminated three-dimensional rigid bodies 101, 102 herein above. Preferably, the second rigid body 102 may be the above-described laminated three-dimensional body 102. This is exemplarily illustrated in FIG. 5. More preferred, the second rigid body 102 may be identical to the first rigid body 101. For example, the first rigid body 101 and the second rigid body 102 may form corresponding halves of a receptacle like a bottle for receiving a liquid, such as water. However, it is also conceivable that the second rigid body 102 may be different from the above-described laminated three-dimensional body 101. For instance, the second rigid body 102 may be a plate or a cover for closing the body volume 111 enclosed by the first rigid body 101. The second rigid body 102 may be made of a different or the same material(s) as the first rigid body 101.

The first rigid body 101 and the second rigid body 102 are connected to each other. Preferably, the first rigid body 101 and the second rigid body 102 may be heat sealed to each other and/or may be sealed onto each other by ultrasonic and/or induction sealing. For example, a seal 330 may be formed along the flange portions 113 of the first rigid body 101 and of the second rigid body 102. This is exemplarily illustrated in FIG. 5. Therein, the two rigid bodies 101, 102 may be aligned such that their flange portions 113 abut. Preferably, the laminate 200 may cover at least one of the respective flange portions 113 to facilitate sealing via the laminate 200. The connection between the first rigid body 101 and the second rigid body 102 may be gas and/or liquid tight.

By connecting the first rigid body 101 and the second rigid body 102 to each other, a partially or fully closed container volume 312 is formed. The container volume 312 is at least partially delimited by the wall section 110. Alternatively or additionally, the container volume 312 comprises at least the body volume 111 of the first rigid body 101. Preferably, the container volume 312 may be at least partially delimited by the wall sections 110 of the first rigid body 101 and the second rigid body 102 together. Alternatively or additionally, the container volume 312 may comprise the body volumes 111 of both of the first rigid body 101 and the second rigid body 102. FIG. 5 shows this exemplarily. Preferably, the container 300 may have a volume between 100 ml and 10 l. However, these are only examples and not to be understood as limiting.

The at least one see-through hole 120 in the container 300 is covered by the laminate 200 to provide at least one level indicator and/or to facilitate for a consumer to inspect the product. Thereby, information can be provided to the consumer and the appeal of the packaged product inside the container 300 can be increased. In addition, it is possible to provide in form of the container 300 that reduces not only the environmental impact of packaging by being producible from recyclable, biodegradable, and/or compostable materials, but that also can be provided with a higher quality of the adherence between the laminate 200 inside the container 330 and the rigid body 100, thereby, leading to an improved storage quality of the products filled inside the container 300. In addition, packaging can be provided in a variety of different sizes and (shell) depths, thus, making packaging available for numerous packaging applications.

The invention is not limited by the embodiments as described hereinabove, as long as being covered by the appended claims. All the features of the embodiments described hereinabove can be combined in any possible way and be provided interchangeably.

1. A vacuum lamination process comprising:
providing a three-dimensional rigid body to be laminated, the body having a wall section delimiting an open body volume, wherein the body comprises a see-through hole penetrating the wall section,
providing a laminate,
spanning the laminate at least over the body volume, and
applying a vacuum at least via the see-through hole so that the laminate is laminated onto the body at least at the wall section to cover the see-through hole.

2. The vacuum lamination process according to claim 1, wherein, before spanning the laminate at least over the body volume, heating the laminate.

3. The vacuum lamination process according to claim 1, wherein, before spanning the laminate at least over the body volume.

4. The vacuum lamination process according to claim 1, wherein the body comprises a plurality of see-through holes.

5. A laminated three-dimensional rigid body comprising a three-dimensional rigid body having a wall section delimiting an open body volume, wherein the body comprises a see-through hole penetrating the wall section, and wherein at least the wall section is laminated with a laminate to cover at least the wall section and the see-through hole.

6. The laminated three-dimensional rigid body according to claim 5, wherein the body comprises a plurality of see-through holes, wherein the plurality of see-through holes is covered by the laminate, and
wherein the see-through hole(s) is/are positioned at or in a transition area of the wall section defining the three-dimensional shape of the body.

7. The laminated three-dimensional rigid body according to claim 5, wherein the see-through holes are evenly or unevenly distributed over the wall section, preferably at or along the transition area if present.

8. The laminated three-dimensional rigid body according to claim 5, wherein the largest extension E of the see-through hole.

9. The laminated three-dimensional rigid body according to claim 5, wherein the body is made from a cellulose material.

10. The laminated three-dimensional rigid body according to claim 5, wherein the body has a material thickness B of 200 μm≤B≤1200 μm.

11. The laminated three-dimensional rigid body according to claim 5, wherein the laminate is made from a material selected from the group consisting of bio-based, petro-based and a biodegradable polymer material.

12. The laminated three-dimensional rigid body according to claim 5, wherein the laminate comprises a layered structure.

13. The laminated three-dimensional rigid body according to claim 5, wherein the laminate has a material thickness T of 25 μm≤T≤150 μm.

14. A container, comprising a first rigid body being a laminated three-dimensional rigid body comprising:
providing a three-dimensional rigid body to be laminated, the body having a wall section delimiting an open body volume, wherein the body comprises a see-through hole penetrating the wall section,
providing a laminate,
spanning the laminate at least over the body volume, and
applying a vacuum at least via the see-through hole so that the laminate is laminated onto the body at least at the wall section to cover the see-through hole, and a second rigid body, wherein the first rigid body and the second rigid body are connected to each other to form a partially or fully closed container volume that is at least partially delimited by the wall section or that comprises at least the body volume of the first rigid body.

15. (canceled)
